(19) United States
(12) Patent Application Publication
(10) Pub. No.: US 2024/0188087 A1
(43) Pub. Date: Jun. 6, 2024

(54) METHOD FOR UCI TRANSMISSION AND RELATED APPARATUSES

(71) Applicant: BEIJING UNISOC COMMUNICATIONS TECHNOLOGY CO., LTD., Beijing (CN)

(72) Inventor: Huan ZHOU, Beijing (CN)

(21) Appl. No.: 18/552,958

(22) PCT Filed: Apr. 1, 2022
(86) PCT No.: PCT/CN2022/084832

§ 371 Date: Sep. 28, 2023

(30) Foreign Application Priority Data
Apr. 6, 2021 (CN) 202110369903.7

(51) Int. Cl. H04W 72/21; H04L 1/00; H04W 72/0446

(52) U.S. Cl. CPC H04W 72/21; H04L 1/0067; H04W 72/0446

(57) ABSTRACT

A method for uplink control information (UCI) transmission and related apparatuses are provided. The method includes the following. A terminal transmits UCI by using a first slot for a transport block (TB) processing over multi-slot (TBoMS) physical uplink shared channel (PUSCH).

### CROSS-REFERENCE TO RELATED APPLICATION(S)

This application is a National Stage of International Application No. PCT/CN2022/084832, field Apr. 1, 2022, which claims priority to Chinese Patent Application No. 202110369903.7, filed Apr. 6, 2021, the entire disclosures of which are hereby incorporated by reference.

### TECHNICAL FIELD

The disclosure relates to the field of wireless communication technology, and more particularly, to a method for uplink control information (UCI) transmission and related apparatuses.

### BACKGROUND

Currently, when transmitting a physical uplink shared channel (PUSCH) over multiple slots, how to map uplink control information (UCI) onto the transport block (TB) processing over multi-slot (TBoMS) PUSCH in order for transmission is not yet specified in a protocol.

### SUMMARY

In a first aspect, a method for UCI transmission is provided in embodiments of the disclosure. The method includes the following. A terminal transmits UCI by using a first slot for a TBoMB PUSCH.

In a second aspect, a terminal is provided in embodiments of the disclosure. The terminal includes a transceiver, a processor, a memory, and one or more programs. The one or more programs are stored in the memory and configured to be executed by the processor. The programs include instructions for implementing steps in the method described in the first aspect.

In a third aspect, a non-transitory computer-readable storage medium is provided in embodiments of the disclosure. The computer-readable storage medium is configured to store computer programs for electronic data interchange (EDI). The computer programs are operable with a computer to execute instructions for the method described in the first aspect.

### BRIEF DESCRIPTION OF THE DRAWINGS

FIG. 1A is an architectural diagram of a mobile communication system 10 provided in embodiments of the disclosure.

FIG. 1B is a schematic structural diagram of a terminal 100 provided in embodiments of the disclosure.

FIG. 2A is a schematic flowchart of a method for uplink control information (UCI) transmission provided in embodiments of the disclosure.

FIG. 2B is a schematic diagram illustrating multiplexing of UCI on a transport block (TB) processing over multi-slot (TBoMS) physical uplink shared channel (PUSCH) provided in embodiments of the disclosure.

FIG. 2C is a schematic diagram illustrating another multiplexing of UCI on a TBoMS PUSCH provided in embodiments of the disclosure.

FIG. 2D is a schematic diagram illustrating another multiplexing of UCI on a TBoMS PUSCH provided in embodiments of the disclosure.

FIG. 3 is a block diagram illustrating functional units of an apparatus 3 for UCI transmission provided in embodiments of the disclosure.

FIG. 4 is a block diagram illustrating functional units of another apparatus 4 for UCI transmission provided in embodiments of the disclosure.

FIG. 5 is a block diagram illustrating functional units of an apparatus 5 for UCI transmission provided in embodiments of the disclosure.

FIG. 6 is a block diagram illustrating functional units of another apparatus 6 for UCI transmission provided in embodiments of the disclosure.

### DETAILED DESCRIPTION

In order for those skilled in the art to better understand the solutions of the disclosure, the following will describe clearly and completely the technical solutions of embodiments of the disclosure with reference to the accompanying drawings in the embodiments of the disclosure. Apparently, embodiments described herein are merely some embodiments, rather than all embodiments, of the disclosure. Based on the embodiments of the disclosure, all other embodiments obtained by those of ordinary skill in the art without creative effort shall fall within the protection scope of the disclosure.

The terms “first”, “second”, etc. in the specification and claims of the disclosure and in the accompanying drawings are intended for distinguishing different objects rather than describing a particular order. In addition, the terms “include”, “comprise”, and “have” as well as variations thereof are intended to cover non-exclusive inclusion. For example, a process, method, system, product, or device including a series of steps or units is not limited to the listed steps or units, instead, it may optionally include other steps or units that are not listed, or may optionally include other steps or units inherent to the process, method, product, or device.

The term “embodiment” referred to herein means that a particular feature, structure, or characteristic described in conjunction with the embodiment may be contained in at least one embodiment of the disclosure. The phrase appearing in various places in the specification does not necessarily refer to the same embodiment, nor does it refer to an independent or alternative embodiment that is mutually exclusive with other embodiments. It is explicitly and implicitly understood by those skilled in the art that an embodiment described herein may be combined with other embodiments.

Embodiments of the disclosure provide a method for uplink control information (UCI) transmission and related apparatuses. The embodiments of the disclosure will be described in detail below with reference to the accompanying drawings.

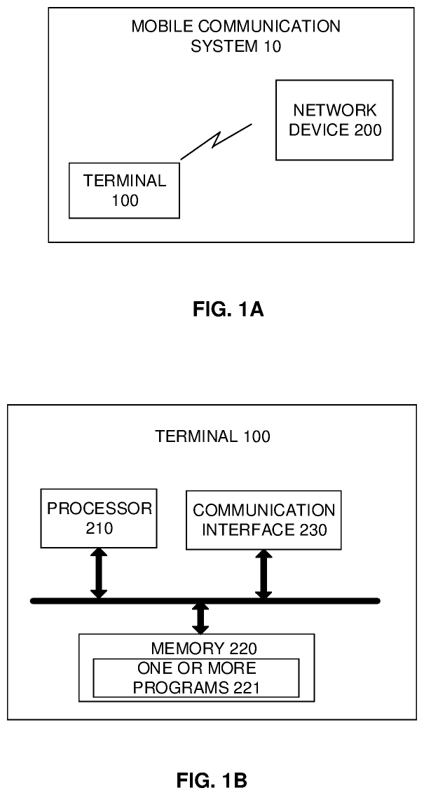

Refering to FIG. 1A, FIG. 1A is an architectural diagram of a mobile communication system 10 provided in embodiments of the disclosure. The mobile communication system 10 may be a long term evolution (LTE) system, or may be a next-generation evolution system based on an LTE system, such as an LTE-advanced (LTE-A) system or a 5^{th} generation(5G) system (also referred to as a new radio (NR) system), or may be a next-generation evolution system based on a 5G system. In embodiments of the disclosure, the terms “system” and “network” are usually used interchangeably, but the meaning thereof can be understood by those skilled in the art.

The mobile communication system 10 includes a terminal(s) 100 at a user side and a network device 200 at a network side. The terminal 100 is in communication connection with the network device 200.

The network device 200 may be a 5G base station, a 5G access point (AP), or the like, which is not limited herein. The base station may include different types such as a macro base station, a micro base station, a relay station, and an AP. In some embodiments, a base station may be referred to by those skilled in the art as a base transceiver station, a radio base station, an AP, a radio transceiver, a basic service set (BSS), an extended service set (ESS), a NodeB, an evolved NodeB (eNB or eNodeB), or some other suitable terms. For example, in a 5G system, the base station is referred to as a gNB.

The terminals 100 may be distributed throughout the mobile communication system, and each terminal 100 may be stationary or mobile. The terminal 100 may also be referred to by those skilled in the art as a mobile station, a subscriber station, a mobile unit, a subscriber unit, a wireless unit, a remote unit, a mobile device, a user equipment (UE), a wireless device, a wireless communication device, a remote device, a mobile subscriber station, an access terminal, a mobile terminal, a wireless terminal, a remote terminal, a handheld device, a user agent, a mobile client, a client, or some other suitable terms. The terminal 100 may be a cellular radio telephone, a personal digital assistant (PDA), a wireless modem, a wireless communication device, a handheld device, a tablet computer, a laptop computer, a cordless phone, a wireless local loop (WLL) station, or the like. The terminal 100 is capable of communicating with an access-network device in the mobile communication system.

The communication system and the service scenario described in embodiments of the disclosure are intended to illustrate more clearly the technical solutions of embodiments of the disclosure, and do not constitute limitation on the technical solutions provided in embodiments of the present disclosure. Those of ordinary skill in the art can appreciate that, with evolution of communication systems and emergence of new service scenarios, for similar technical problems, the technical solutions provided in embodiments of the disclosure are also applicable.

As illustrated in FIG. 1B, which is a schematic structural diagram of a terminal 100, the terminal 100 provided in embodiments of the disclosure includes a processor 210, a memory 220, a communication interface 230, and one or more programs 221. The one or more programs 221 are stored in the memory 220 and configured to be executed by the processor 210. The programs 221 include instructions for implementing the method described in method embodiments of the disclosure.

Currently, in each hopping of a physical uplink shared channel (PUSCH), a hybrid automatic repeat request-acknowledgement (HARQ-ACK) is mapped starting from a 1^{st} symbol after a front-loaded demodulation reference signal (DMRS) symbol; channel state information 1 (CSI 1) is mapped starting from a 1^{st} non-DMRS symbol for the PUSCH, where the CSI 1 is not mapped onto a position of a resource element (RE) reserved for the HARQ-ACK or a position of an RE onto which the HARQ-ACK is mapped, and is not frequency-division multiplexed with a DMRS for the PUSCH; CSI 2 is mapped starting from the 1^{st} non-DMRS symbol for the PUSCH, where the CSI 2 can be mapped onto a position of an RE reserved for the HARQ-ACK and is not mapped onto a position of an RE onto which the HARQ-ACK is mapped and a position of an RE onto which the CSI 1 is mapped, and is not frequency-division multiplexed with the DMRS for the PUSCH.

Positions of REs occupied by the HARQ-ACK, the CSI 1, and the CSI 2 in each symbol are as follows: reported information is mapped onto REs based on distributed mapping, and an interval d is as follows:
(1) If the number (that is, quantity) of symbols for unmapped reported information after scheduling is greater than the number of available REs in an orthogonal frequency division multiplexing (OFDM) symbol, d=1. That is, if there is still reported information unmapped, the reported information continues to be mapped onto a next OFDM symbol.
(2) If the number of symbols for the unmapped report information after scheduling is less than the number of available REs in an OFDM symbol, d=floor (the number of available REs in an OFDM symbol ÷ the number of symbols for the reported information after scheduling).

In a 5G communication service, in order to improve resource utilization efficiency, user terminals with different data transmission durations can be multiplexed on the same time-frequency physical resource. For example, an ultra reliable & low latency communication (URLLC) user terminal has a short transmission-duration, and thus is a short-time-duration user terminal. An enhanced mobile broadband (eMBB) user terminal has a long transmission-duration, and thus is a long-time-duration user terminal. In order to ensure an URLLC service, in NR release 16 (Rel-16), an uplink (UL) channel including a physical uplink control channel (PUCCH) UCI is introduce, and PUSCH is configured to be has high priority (HP)/low priority (LP). If an HP UL channel and an LP UL channel are overlapped in time, it is necessary to discard the LP UL channel, and only the HP UL channel will be transmitted. Trigger of aperiodic CSI (A-CSI) by UL downlink control information (DCI) in an NR system includes the following steps.

Step 1, an A-CSI trigger state list is configured via higher-layer signaling, i. e. radio resource control (RRC), where the A-CSI trigger state list includes M A-CSI triggering states, and M is a positive integer. An A-CSI triggering state contains N_{Rep} pieces of A-CSI reporting-related configuration information, and a slot interval for a j^{th} A-CSI reporting is Yⱼ.The number N of bits in an A-CSI request field in DCI will be configured via the higher-layer signaling, i. e. RRC. If 2\hat{ }N−1≥M, perform step 2; otherwise, perform step 3.

Step 2, a media access control—control element (MAC CE) may select several A-CSI triggering states from the A-CSI trigger state list.

Step 3, the DCI contains a CSI request field, where the CSI request field indicates to initiate an A-CSI triggering state.

Step 4, after receiving the DCI, a UE measures a CSI reporting—related reference signal (RS) configuration.

If only A-CSI reporting is triggered by the DCI, a slot for A-CSI feedback on a PUSCH is

$${K}_{2} = {max}_{j} {Y}_{j} ( m + 1 ) ,$$

where Yⱼ, j=0, . . . , N_{Rep}−1, and m=0−M.

If A-CSI reporting as well as PUSCH scheduling is triggered by the DCI, A-CSI reporting will be performed on a PUSCH resource indicated by the UL DCI.

Currently, in order to facilitate enhanced UL coverage by a base station, a PUSCH corresponding to one transport block (TB) is transmitted across multiple slots. To this end, the disclosure provides a scheme for multiplexing UCI on a TB processing over multi-slot (TBoMS) PUSCH.

Detailed elaborations will be given below with reference to the accompanying drawings.

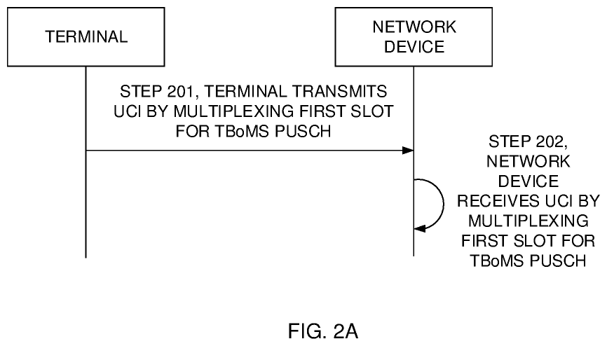

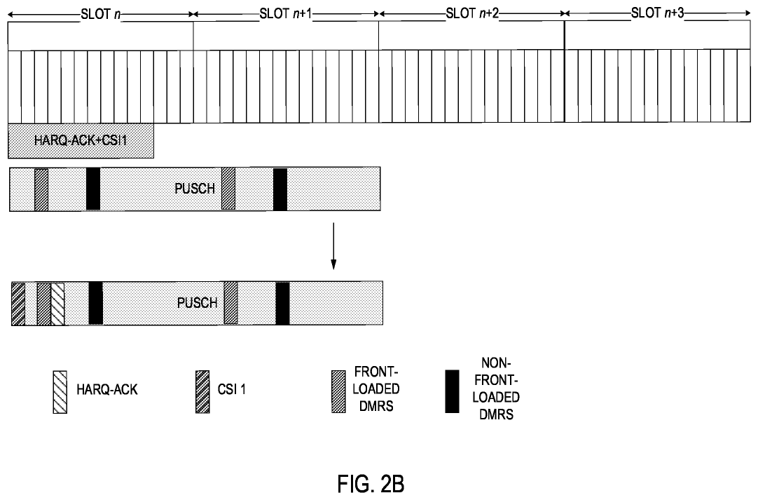

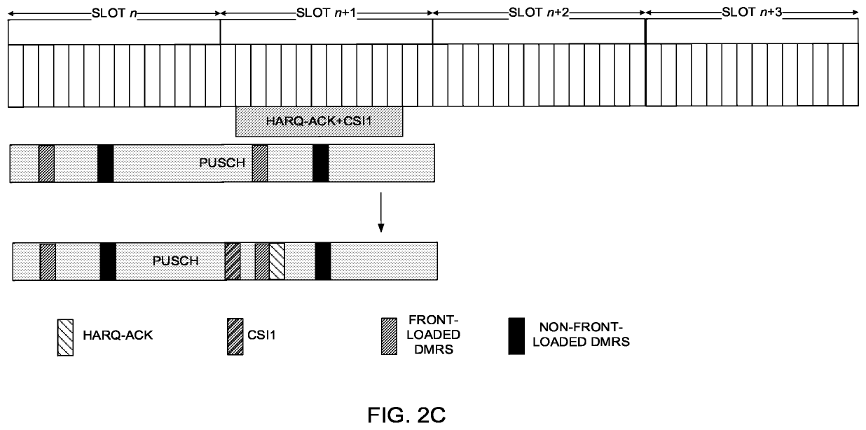

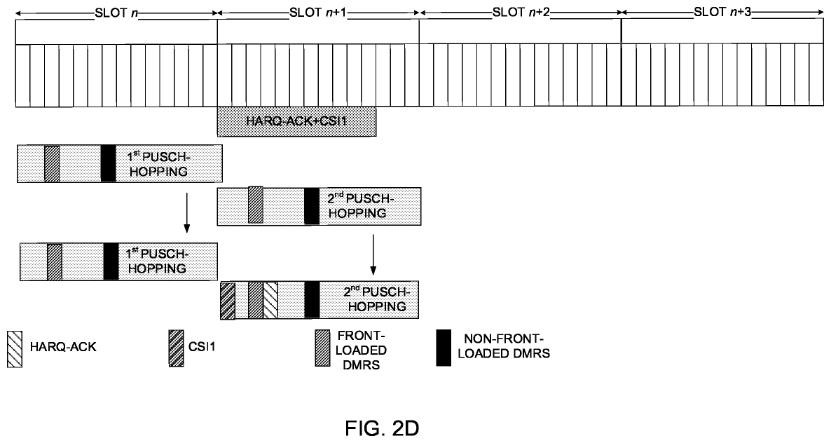

Referring to FIG. 2A, FIG. 2A is a schematic flowchart of a method for UCI transmission provided in embodiments of the disclosure. The method is applied to the terminal 100 and the network device 200 in the mobile communication system 10 illustrated in FIG. 1A. The method includes the following.

Step 201, a terminal transmits UCI by using a first slot for a TBoMS PUSCH.

The TBoMS PUSCH refers to a PUSCH occupying at least two consecutive slots.

The first slot should be understood as a 1^{st} slot of the TBoMS PUSCH from which mapping of the UCI starts, and a slot after the 1^{st} slot of the TBoMS PUSCH may also be multiplexed for mapping the UCI in order for UCI transmission. For example, if the TBoMS PUSCH and a PUCCH have two overlapped slots, the 1^{st} overlapped slot may be a 1^{st} slot in the two overlapped slots, and the UCI in a corresponding slot will also be mapped onto a 2^{nd} slot in the two overlapped slots in order for multiplexed transmission.

Step 202, a network device receives the UCI by using the first slot for the TBoMS PUSCH.

In a possible example, the UCI includes at least one of: a HARQ-ACK and/or configured grant (CG)-UCI, CSI 1, or CS 2.

In this possible example, some or all of slots for the TBoMS PUSCH overlap with a transmission slot for a PUCCH for the terminal.

In a possible example, the first slot is a slot in which the TBoMS PUSCH overlaps with the PUCCH.

If the slot where the TBoMS PUSCH overlaps with the PUCCH includes multiple slots, each of the multiple slots will be mapped onto.

In a possible example, if the UCI includes the HARQ-ACK and/or the CG-UCI, the HARQ-ACK and/or the CG-UCI is mapped starting from a 1^{st} symbol after a front-loaded DMRS symbol in each overlapped slot for the TBoMS PUSCH, or the HARQ-ACK and/or the CG-UCI is mapped starting from a 1^{st} symbol after a front-loaded DMRS symbol in each overlapped slot for actual transmission of the TBoMS PUSCH. If the UCI includes the HARQ-ACK and the CG-UCI, information obtained by jointly encoding the HARQ-ACK and the CG-UCI is mapped starting from the 1^{st} symbol after the front-loaded DMRS symbol in each overlapped slot for the TBoMS PUSCH, or the information obtained by jointly encoding the HARQ-ACK and the CG-UCI is mapped starting from the 1^{st} symbol after the front-loaded DMRS symbol in each overlapped slot for actual transmission of the TBoMS PUSCH. The CSI 1 is mapped starting from a 1^{st} non-DMRS symbol in each overlapped slot for the TBoMS PUSCH, where the CSI 1 is not mapped onto a position of an RE reserved for the HARQ-ACK and a position of an RE onto which the HARQ-ACK is mapped, and is not frequency-division multiplexed with a DMRS for the TBoMS PUSCH. The CSI 2 is mapped starting from the 1^{st} non-DMRS symbol in each overlapped slot for the TBoMS PUSCH, where the CSI 2 can be mapped onto a position of an RE reserved for the HARQ-ACK, and is not mapped onto a position of an RE onto which the HARQ-ACK is mapped and a position of an RE onto which the CSI 1 is mapped, and is not frequency-division multiplexed with the DMRS for the TBoMS PUSCH.

For example, as illustrated in FIG. 2B, the PUCCH (HARQ-ACK+CSI 1) and a 1^{st} slot (slot n) for the TBoMS PUSCH partially overlap. The TBoMS PUSCH spans slot n and slot n+1. In slot n, a front-loaded DMRS is on symbol 2, and a non-front-loaded DMRS is on symbol 6. The same is applied to slot n+1. Then, according to mapping requirements on the HARQ-ACK and the CSI 1, it can be determined that the CSI 1 can be mapped starting from symbol 0 in overlapped slot n, and the HARQ-ACK can be mapped starting from a 1^{st} symbol, i. e. symbol 3, after symbol 2 on which the front-loaded DMRS is located (i. e. the front-loaded DMRS symbol) in overlapped slot n.

For another example, as illustrated in FIG. 2C, the PUCCH (HARQ-ACK+CSI 1) and a 2^{nd} slot (slot n+1) for the TBoMS PUSCH partially overlap. The TBoMS PUSCH spans slot n and slot n+1. In slot n, a front-loaded DMRS is on symbol 2, and a non-front-loaded DMRS is on symbol 6. The same is applied to slot n+1. Then, according to mapping requirements on the HARQ-ACK and the CSI 1, it can be determined that the CSI I can be mapped starting from symbol 0 in overlapped slot n+1, and the HARQ-ACK can be mapped starting from a 1^{st} symbol, i. e. symbol 3, after symbol 2, on which the front-loaded DMRS is located, in overlapped slot n+1.

For another example, as illustrated in FIG. 2D, the PUCCH (HARQ-ACK+CSI 1) and a 2^{nd} hopping (slot n+1) of the TBoMS PUSCH partially overlap. The TBoMS PUSCH spans slot n and slot n+1. In slot n, a front-loaded DMRS is on symbol 2, and a non-front-loaded DMRS is on symbol 6. The same is applied to slot n+1. Then, according to mapping requirements on the HARQ-ACK and the CSI 1, it can be determined that the CSI I can be mapped starting from symbol 0 in the 2^{nd} hopping (i. e. overlapped slot n+1), and the HARQ-ACK can be mapped starting from a 1^{st} symbol, i. e. symbol 3, after symbol 2, on which the front-loaded DMRS is located, in the 2^{nd} hopping (i. e. overlapped slot n+1).

As can be seen, in this example, for the case where the TBoMS PUSCH and the PUCCH have an overlapped slot, with aid of a system, it is possible to map corresponding UCI onto each overlapped slot for the TBoMS PUSCH, such that the UCI can be multiplexed on the TBoMS PUSCH.

In a possible example, if a slot in which the TBoMS PUSCH overlaps with the transmission slot for the PUCCH for the terminal is a 1^{st} slot for the TBoMS PUSCH, in UCI multiplexing, an RE onto which the TBoMS PUSCH is mapped will be occupied in a rate matching manner. If a slot in which the TBoMS PUSCH overlaps with the transmission slot for the PUCCH for the terminal is not the 1^{st} slot for the TBoMS PUSCH, in UCI multiplexing, an RE onto which the TBoMS PUSCH is mapped will be occupied in a puncturing manner.

In UCI multiplexing, if an RE resource corresponding to a PUSCH is to be occupied based on rate matching, when calculating an available RE resource for the PUSCH, an RE(s) occupied by UCI multiplexing will be excluded first, and then rate matching of an UL-shared channel (SCH) will be performed.

In UCI multiplexing, if a corresponding RE resource is to be occupied based on puncturing (where puncturing is not an existing UCI multiplexing mode), when calculating an available RE resource for a PUSCH, it is unnecessary to firstly exclude an RE occupied by UCI multiplexing in a non-1^{st} slot, and rate matching of an UL-SCH is directly performed after performing the UL-SCH. At the position of a corresponding RE, information obtained after UCI encoding covers original information obtained after UL-SCH encoding.

In addition, when calculating the number of REs by a device, only the number of symbols allocated in the slot is involved, rather than the number of all symbols.

As can be seen, in this example, it is possible for the device to flexibly select a multiplexing mode that is suitable, which is conducive to flexibility and convenience.

As can be seen, in embodiments of the disclosure, the terminal can transmit the UCI by using the first slot for the TBoMS PUSCH, such that the UCI can be mapped onto the TBoMS PUSCH and transmitted, which facilitates UCI transmission on the TBOMB PUSCH, thereby assisting downlink scheduling by providing UCI and thus improving system performance.

Embodiments of the disclosure provide an apparatus for UCI transmission. The apparatus may be a terminal. Specifically, the apparatus is configured to implement steps performed by the terminal in the foregoing method. The apparatus provided in embodiments of the disclosure may include modules corresponding to these steps.

In embodiments of the disclosure, division of functional modules of the apparatus may be implemented according to the foregoing method embodiments. For example, various functional modules may be divided to be in one-to-one correspondence with each function, or two or more functions may be integrated into one processing module. The integrated module may be implemented in the form of hardware, or may be implemented in the form of software functional module. Division of modules in embodiments of the disclosure is illustrative and is only a division of logical functions, and other manners of division may be available in practice.

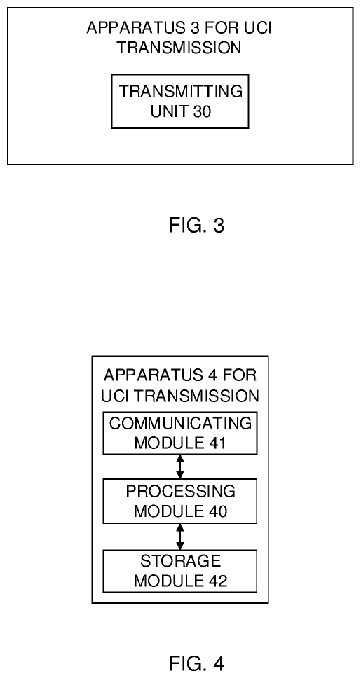

If various functional modules are divided to be in one-to-one correspondence with each function, FIG. 3 is a possible structural diagram of an apparatus for UCI transmission involved in the foregoing embodiments. As illustrated in FIG. 3, the apparatus 3 for UCI transmission is applied to a terminal. The apparatus includes a transmitting unit 30. The transmitting unit 30 is configured to transmit UCI by using a first slot for a TBoMS PUSCH.

In a possible example, the UCI includes at least one of: a HARQ-ACK and/or CG-UCI, CSI 1, or CSI 2.

In a possible example, some or all of slots for the TBoMS PUSCH overlap with a transmission slot for a PUCCH for the terminal.

In a possible example, the first slot is a slot in which the TBoMS PUSCH overlaps with the PUCCH.

In a possible example, if the UCI includes the HARQ-ACK and/or the CG-UCI, the HARQ-ACK and/or the CG-UCI is mapped starting from a 1^{st} symbol after a front-loaded DMRS symbol in each overlapped slot for the TBoMS PUSCH, or the HARQ-ACK and/or the CG-UCI is mapped starting from a 1^{st} symbol after a front-loaded DMRS symbol in each overlapped slot for actual transmission of the TBoMS PUSCH. If the UCI includes the HARQ-ACK and the CG-UCI, information obtained by jointly encoding the HARQ-ACK and the CG-UCI is mapped starting from the 1^{st} symbol after the front-loaded DMRS symbol in each overlapped slot for the TBoMS PUSCH, or the information obtained by jointly encoding the HARQ-ACK and the CG-UCI is mapped starting from the 1^{st} symbol after the front-loaded DMRS symbol in each overlapped slot for actual transmission of the TBoMS PUSCH. The CSI 1 is mapped starting from a 1st non-DMRS symbol in each overlapped slot for the TBoMS PUSCH, where the CSI 1 is not mapped onto a position of an RE reserved for the HARQ-ACK and a position of an RE onto which the HARQ-ACK is mapped, and is not frequency-division multiplexed with a DMRS for the TBoMS PUSCH. The CSI 2 is mapped starting from the 1^{st} non-DMRS symbol in each overlapped slot for the TBoMS PUSCH, where the CSI 2 can be mapped onto a position of an RE reserved for the HARQ-ACK, and is not mapped onto a position of an RE onto which the HARQ-ACK is mapped and a position of an RE onto which the CSI 1 is mapped, and is not frequency-division multiplexed with the DMRS for the TBoMS PUSCH.

In a possible example, if a slot in which the TBoMS PUSCH overlaps with the transmission slot for the PUCCH for the terminal is a 1^{st} slot for the TBoMS PUSCH, in UCI multiplexing, an RE onto which the TBoMS PUSCH is mapped will be occupied based on rate matching. If a slot in which the TBoMS PUSCH overlaps with the transmission slot for the PUCCH for the terminal is not the 1^{st} slot for the TBoMS PUSCH, in UCI multiplexing, an RE onto which the TBoMS PUSCH is mapped will be occupied based on puncturing.

If an integrated unit is adopted, FIG. 4 is a schematic structural diagram of another apparatus for UCI transmission provided in embodiments of the disclosure. In FIG. 4, the apparatus 4 for UCI transmission includes a processing module 40 and a communicating module 41. The processing module 40 is configured to control and manage actions of the apparatus, for example, steps performed by the transmitting unit 30, and/or to implement other operations of the technology described herein. The communicating module 41 is configured to support the apparatus to interact with other devices. As illustrated in FIG. 4, the apparatus may further include a storage module 42. The storage module 42 is configured to store program codes and data of the apparatus.

The processing module 40 may be a processor or a controller, and may be, for example, a central processing unit (CPU), a general-purpose processor, a digital signal processor (DSP), an application-specific integrated circuit (ASIC), a field programmable gate array (FPGA), or other programmable logic devices, transistor logic devices, hardware components, or any combination thereof. Various illustrative logic blocks, modules, and circuits described in connection with the disclosure can be implemented or executed. The processor may also be a combination for implementing computing functions, for example, a combination that includes one or more microprocessors, a combination of a DSP and a microprocessor, and the like. The communicating module 41 may be a transceiver, a radio frequency (RF) circuit, or a communication interface, or the like. The storage module 42 may be a memory.

All related contents regarding various scenarios involved in the foregoing method embodiments may be applied to functional illustration of corresponding functional modules, which is not described again herein. Both the apparatus 3 for UCI transmission and the apparatus 4 for UCI transmission can implement the steps performed by the terminal in the foregoing method illustrated in FIG. 2A.

Embodiments of the disclosure provide an apparatus for UCI transmission. The apparatus may be a network device. Specifically, the apparatus is configured to implement steps performed by the network device in the foregoing method. The apparatus provided in embodiments of the disclosure may include modules corresponding to these steps.

In embodiments of the disclosure, division of functional modules of the apparatus may be implemented according to the foregoing method embodiments. For example, various functional modules may be divided to be in one-to-one correspondence with each function, or two or more functions may be integrated into one processing module. The integrated module may be implemented in the form of hardware, or may be implemented in the form of software functional module. Division of modules in embodiments of the disclosure is illustrative and is only a division of logical functions, and other manners of division may be available in practice.

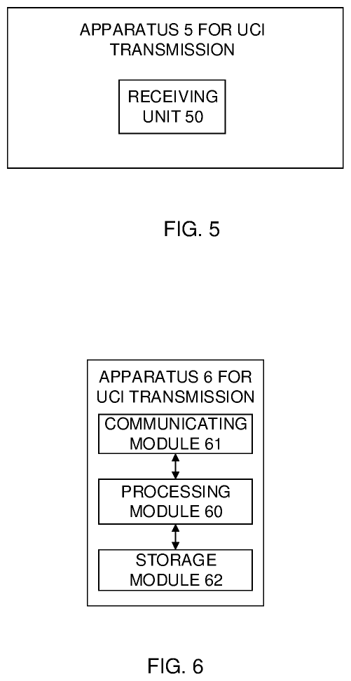

If various functional modules are divided to be in one-to-one correspondence with each function, FIG. 5 is a possible structural diagram of an apparatus for UCI transmission involved in the foregoing embodiments. As illustrated in FIG. 5, the apparatus 5 for UCI transmission is applied to a network device. The apparatus includes a receiving unit 50. The receiving unit 50 is configured to receive UCI by using a first slot for a TBoMS PUSCH.

In a possible example, the UCI includes at least one of: a HARQ-ACK and/or CG-UCI, CSI 1, or CSI 2.

In a possible example, some or all of slots for the TBoMS PUSCH overlap with a transmission slot for a PUCCH for the terminal.

In a possible example, the first slot is a slot in which the TBoMS PUSCH overlaps with the PUCCH.

In a possible example, if the UCI includes the HARQ-ACK and/or the CG-UCI, the HARQ-ACK and/or the CG-UCI is mapped starting from a 1^{st} symbol after a front-loaded DMRS symbol in each overlapped slot for the TBoMS PUSCH, or the HARQ-ACK and/or the CG-UCI is mapped starting from a 1^{st} symbol after a front-loaded DMRS symbol in each overlapped slot for actual transmission of the TBoMS PUSCH. If the UCI includes the HARQ-ACK and the CG-UCI, information obtained by jointly encoding the HARQ-ACK and the CG-UCI is mapped starting from the 1^{st} symbol after the front-loaded DMRS symbol in each overlapped slot for the TBoMS PUSCH, or the information obtained by jointly encoding the HARQ-ACK and the CG-UCI is mapped starting from the 1^{st} symbol after the front-loaded DMRS symbol in each overlapped slot for actual transmission of the TBoMS PUSCH. The CSI 1 is mapped starting from a 1st non-DMRS symbol in each overlapped slot for the TBoMS PUSCH, where the CSI 1 is not mapped onto a position of an RE reserved for the HARQ-ACK and a position of an RE onto which the HARQ-ACK is mapped, and is not frequency-division multiplexed with a DMRS for the TBoMS PUSCH. The CSI 2 is mapped starting from the 1^{st} non-DMRS symbol in each overlapped slot for the TBoMS PUSCH, where the CSI 2 can be mapped onto a position of an RE reserved for the HARQ-ACK, and is not mapped onto a position of an RE onto which the HARQ-ACK is mapped and a position of an RE onto which the CSI 1 is mapped, and is not frequency-division multiplexed with the DMRS for the TBoMS PUSCH.

In a possible example, if a slot in which the TBoMS PUSCH overlaps with the transmission slot for the PUCCH for the terminal is a 1^{st} slot for the TBoMS PUSCH, in UCI multiplexing, an RE onto which the TBoMS PUSCH is mapped will be occupied based on rate matching. If a slot in which the TBoMS PUSCH overlaps with the transmission slot for the PUCCH for the terminal is not the 1^{st} slot for the TBoMS PUSCH, in UCI multiplexing, an RE onto which the TBoMS PUSCH is mapped will be occupied based on puncturing.

If an integrated unit is adopted, FIG. 6 is a schematic structural diagram of another apparatus for UCI transmission provided in embodiments of the disclosure. In FIG. 6, the apparatus 6 for UCI transmission includes a processing module 60 and a communicating module 61. The processing module 60 is configured to control and manage actions of the apparatus, for example, steps performed by the receiving unit 50 and/or for to implement other operations of the technology described herein. The communicating module 61 is configured to support the apparatus to interact with other devices. As illustrated in FIG. 6, the apparatus may further include a storage module 62. The storage module 62 is configured to store program codes and data of the apparatus.

The processing module 60 may be a processor or a controller, and may be, for example, a CPU, a general-purpose processor, a DSP, an ASIC, an FPGA, or other programmable logic devices, transistor logic devices, hardware components, or any combination thereof. Various illustrative logic blocks, modules, and circuits described in connection with the disclosure can be implemented or executed. The processor may also be a combination for implementing computing functions, for example, a combination that includes one or more microprocessors, a combination of a DSP and a microprocessor, and the like. The communicating module 61 may be a transceiver, an RF circuit, or a communication interface, or the like, and the storage module 62 may be a memory.

All related contents regarding various scenarios involved in the foregoing method embodiments may be applied to functional illustration of corresponding functional modules, which is not described again herein. Both the apparatus 5 for UCI transmission and the apparatus 6 for UCI transmission can implement the steps performed by the network device in the foregoing method illustrated in FIG. 2A.

Embodiments of the disclosure provide a chip. The chip is configured to output UCI by multiplexing a first slot for a TBoMS PUSCH.

Embodiments of the disclosure provide a chip module. The chip module includes a transceiver assembly and a chip. The chip configured to transmit, via the transceiver assembly, UCI by using a first slot for a TBoMS PUSCH.

Embodiments of the disclosure provide a chip. The chip is configured to obtain UCI by multiplexing a first slot for a TBoMS PUSCH.

Embodiments of the disclosure provide a chip module. The chip module includes a transceiver assembly and a chip. The chip is configured to receive, via the transceiver assembly, UCI by using a first slot for a TBoMS PUSCH.

All or some of the foregoing embodiments can be implemented through software, hardware, firmware, or any other combination thereof. When implemented by software, all or some of the foregoing embodiments can be implemented in the form of a computer program product. The computer program product includes one or more computer instructions or computer programs. When the computer instructions or computer programs are applied and executed on a computer, all or some of the operations or functions of the embodiments of the disclosure are performed. The computer can be a general-purpose computer, a special-purpose computer, a computer network, or other programmable apparatuses. The computer instruction can be stored in a computer-readable storage medium, or transmitted from one computer-readable storage medium to another computer-readable storage medium. For example, the computer instructions can be transmitted from one website, computer, server, or data center to another website, computer, server, or data center in a wired manner or in a wireless manner. The computer readable storage medium can be any computer accessible usable-medium or a data storage device such as a server, a data center, or the like which integrates one or more usable media. The usable medium can be a magnetic medium (such as a soft disc, a hard disc, or a magnetic tape), an optical medium (such as a digital video disc (DVD)), or a semiconductor medium. The semiconductor medium may be a solid state disk (SSD).

Embodiments of the disclosure further provide a computer storage medium. The computer storage medium is configured to store computer programs for electronic data interchange (EDI). The computer programs are operable with a computer to implement some or all of the steps of any method described in the foregoing method embodiments. The computer includes an electronic device.

Embodiments of the disclosure further provide a computer program product. The computer program product includes a non-transitory computer-readable storage medium storing computer programs. The computer programs are operable with a computer to implement some or all of the steps of any method described in the foregoing method embodiments. The computer program product may be a software installation package, and the computer includes an electronic device.

It should be understood that, in various embodiments of the disclosure, the magnitude of a sequence number of each process does not mean an order of execution, and the order of execution of each process should be determined by its function and an internal logic and shall not constitute any limitation to an implementation process of implementations.

In the several embodiments provided in the disclosure, it should be understood that, the methods, apparatuses, and systems disclosed in embodiments of the disclosure may also be implemented in various other manners. For example, the above apparatus embodiments are merely illustrative, e.g., the division of units is only a division of logical functions, and other manners of division may be available in practice, e.g., multiple units or assemblies may be combined or may be integrated into another system, or some features may be ignored or skipped. In other respects, the coupling or direct coupling or communication connection as illustrated or discussed may be an indirect coupling or communication connection through some interface, device, or unit, and may be electrical, mechanical, or otherwise.

Separated units as illustrated may or may not be physically separated. Components displayed as units may or may not be physical units, and may reside at one location or may be distributed to multiple networked units. Some or all of the units may be selectively adopted according to practical needs to achieve desired objectives of the disclosure.

In addition, various functional units described in various embodiments of the disclosure may be integrated into one processing unit or may be present as a number of physically separated units, and two or more units may be integrated into one. The integrated unit may be implemented in the form of hardware, or may be implemented in the form of hardware and a software functional unit.

The integrated unit implemented as software functional unit can be stored in a computer-readable storage medium. The software functional unit is stored in a storage medium and may include multiple instructions that can cause a computer device, e.g., a personal computer, a server, a network device, etc., to execute some operations of the methods described in various embodiments of the disclosure. The above storage medium may include various kinds of media that can store program codes, such as a universal serial bus (USB) flash disk, a mobile hard drive, a read only memory (ROM), a random access memory (RAM), a magnetic disk, or an optical disk.

Although the disclosure is disclosed as above, the disclosure is not limited thereto. Changes or replacements that can be easily thought of by those skilled in the art without departing from the spirit and scope of the disclosure can be made with various changes and modifications, including combinations of the foregoing different functions and steps and including implementations of software and hardware, which shall all belong to the protection scope of the disclosure.

1. A method for uplink control information (UCI) transmission, comprising:
transmitting, by a terminal, UCI by using a first slot for a transport block (TB) processing over multi-slot (TBoMS) physical uplink shared channel (PUSCH).

2. The method of claim 1, wherein the UCI comprises at least one of: a hybrid automatic repeat request-acknowledgement (HARQ-ACK) and/or configured grant (CG)-UCI, channel state information (CSI) 1, or CSI 2.

3. The method of claim 1, wherein some or all of slots for the TBoMS PUSCH overlap with a transmission slot for a physical uplink control channel (PUCCH) for the terminal.

4. The method of claim 3, wherein the first slot is a slot in which the TBoMS PUSCH overlaps with the PUCCH.

5. The method of claim 4, wherein
when the UCI comprises the HARQ-ACK and/or the CG-UCI, the HARQ-ACK and/or the CG-UCI is mapped starting from a 1st symbol after a front-loaded demodulation reference signal (DMRS) symbol in each overlapped slot for the TBoMS PUSCH, or the HARQ-ACK and/or the CG-UCI is mapped starting from a 1^{st} symbol after a front-loaded DMRS symbol in each overlapped slot for actual transmission of the TBoMS PUSCH;
when the UCI comprises the HARQ-ACK and the CG-UCI, information obtained by jointly encoding the HARQ-ACK and the CG-UCI is mapped starting from the 1^{st} symbol after the front-loaded DMRS symbol in each overlapped slot for the TBoMS PUSCH, or the information obtained by jointly encoding the HARQ-ACK and the CG-UCI is mapped starting from the 1^{st} symbol after the front-loaded DMRS symbol in each overlapped slot for actual transmission of the TBoMS PUSCH;
the CSI 1 is mapped starting from a 1^{st} non-DMRS symbol in each overlapped slot for the TBoMS PUSCH, wherein the CSI 1 is not mapped onto a position of a resource element (RE) reserved for the HARQ-ACK and a position of an RE onto which the HARQ-ACK is mapped, and is not frequency-division multiplexed with a DMRS for the TBoMS PUSCH;
the CSI 2 is mapped starting from the 1^{st} non-DMRS symbol in each overlapped slot for the TBoMS PUSCH, wherein the CSI 2 can be mapped onto a position of an RE reserved for the HARQ-ACK, and is not mapped onto a position of an RE onto which the HARQ-ACK is mapped and a position of an RE onto which the CSI 1 is mapped, and is not frequency-division multiplexed with the DMRS for the TBoMS PUSCH.

6. The method of claim 3, wherein
in UCI multiplexing, an RE onto which the TBoMS PUSCH is mapped is occupied based on rate matching, when a slot in which the TBoMS PUSCH overlaps with the transmission slot for the PUCCH for the terminal is a 1^{st} slot for the TBoMS PUSCH.

7. The method of any of claims 3, wherein
in UCI multiplexing, an RE onto which the TBoMS PUSCH is mapped is occupied based on puncturing, when a slot in which the TBoMS PUSCH overlaps with the transmission slot for the PUCCH for the terminal is not a 1^{st} slot for the TBoMS PUSCH.

8-18. (canceled)

19. A terminal, comprising a transceiver, a processor, a memory, and one or more programs, wherein the one or more programs are stored in the memory and configured to be executed by the processor, and the programs comprise instructions for:
causing the transceiver to transmit UCI by using a first slot for a transport block (TB) processing over multi-slot (TBoMS) physical uplink shared channel (PUSCH).

20. (canceled)

21. A non-transitory computer-readable storage medium configured to store computer programs for electronic data interchange (EDI), wherein the computer programs are operable with a computer to execute instructions for:
transmitting UCI by using a first slot for a transport block (TB) processing over multi-slot (TBoMS) physical uplink shared channel (PUSCH).

22-25. (canceled)

26. The terminal of claim 19, wherein the UCI comprises at least one of: a hybrid automatic repeat request-acknowledgement (HARQ-ACK) and/or configured grant (CG)-UCI, channel state information (CSI) 1, or CSI 2.

27. The terminal of claim 19, wherein some or all of slots for the TBoMS PUSCH overlap with a transmission slot for a physical uplink control channel (PUCCH) for the terminal.

28. The terminal of claim 27, wherein the first slot is a slot in which the TBoMS PUSCH overlaps with the PUCCH.

29. The terminal of claim 28, wherein
when the UCI comprises the HARQ-ACK and/or the CG-UCI, the HARQ-ACK and/or the CG-UCI is mapped starting from a 1^{st} symbol after a front-loaded demodulation reference signal (DMRS) symbol in each overlapped slot for the TBoMS PUSCH, or the HARQ-ACK and/or the CG-UCI is mapped starting from a 1^{st} symbol after a front-loaded DMRS symbol in each overlapped slot for actual transmission of the TBoMS PUSCH.

30. The terminal of claim 28, wherein
when the UCI comprises the HARQ-ACK and the CG-UCI, information obtained by jointly encoding the HARQ-ACK and the CG-UCI is mapped starting from the 1^{st} symbol after the front-loaded DMRS symbol in each overlapped slot for the TBoMS PUSCH, or the information obtained by jointly encoding the HARQ-ACK and the CG-UCI is mapped starting from the 1^{st} symbol after the front-loaded DMRS symbol in each overlapped slot for actual transmission of the TBoMS PUSCH.

31. The terminal of claim 28, wherein
the CSI 1 is mapped starting from a 1^{st} non-DMRS symbol in each overlapped slot for the TBoMS PUSCH, wherein the CSI 1 is not mapped onto a position of a resource element (RE) reserved for the HARQ-ACK and a position of an RE onto which the HARQ-ACK is mapped, and is not frequency-division multiplexed with a DMRS for the TBoMS PUSCH.

32. The terminal of claim 28, wherein the CSI 2 is mapped starting from the 1^{st} non-DMRS symbol in each overlapped slot for the TBoMS PUSCH, wherein the CSI 2 can be mapped onto a position of an RE reserved for the HARQ-ACK, and is not mapped onto a position of an RE onto which the HARQ-ACK is mapped and a position of an RE onto which the CSI 1 is mapped, and is not frequency-division multiplexed with the DMRS for the TBoMS PUSCH.

33. The terminal of claim 27, wherein
in UCI multiplexing, an RE onto which the TBoMS PUSCH is mapped is occupied based on rate matching, when a slot in which the TBoMS PUSCH overlaps with the transmission slot for the PUCCH for the terminal is a 1^{st} slot for the TBoMS PUSCH.

34. The terminal of claim 27, wherein
in UCI multiplexing, an RE onto which the TBoMS PUSCH is mapped is occupied based on puncturing, when a slot in which the TBoMS PUSCH overlaps with the transmission slot for the PUCCH for the terminal is not a 1^{st} slot for the TBoMS PUSCH.

35. The non-transitory computer-readable storage medium of claim 21, wherein the UCI comprises at least one of: a hybrid automatic repeat request-acknowledgement (HARQ-ACK) and/or configured grant (CG)-UCI, channel state information (CSI) 1, or CSI 2.

36. The non-transitory computer-readable storage medium of claim 21, wherein some or all of slots for the TBoMS PUSCH overlap with a transmission slot for a physical uplink control channel (PUCCH) for the terminal.
